(19) United States
(12) Patent Application Publication
(10) Pub. No.: US 2004/0036578 A1
(43) Pub. Date: Feb. 26, 2004

(54) Audio/visual warning device for attaching to a cane and the cane therewith

(76) Inventor: Gladys Preston, New York, NY (US)

Correspondence Address: Gladys Preston, Apt. 9-N, 580 Park Avenue, New York, NY, 10021, US

(21) Appl. No.: 10/227,352

(22) Filed: Aug. 26, 2002

(51) Int. Cl. G08B 23/00

(52) U.S. Cl. 340/321; 340/326; 340/574

(57) ABSTRACT

An audio/visual warning device for attaching to a cane. The cane has upper and lower ends and extended and collapsed positions and includes a plurality of tubular members affixed, end-to-end, when in the extended position and folded, side-by-side, when in the collapsed position, and an elastic cord extends axially in the cane and is affixed to the upper and lower ends of the cane, respectively, so as to allow the plurality of tubular members to be maintained, end-to-end, in the extended position, yet be separated axially and be maintained, side-by-side, in the collapsed position. The audio/visual warning device includes a plate, a manual bell, a light, and apparatus for attaching the plate to the upper end of the cane. The manual bell and the light are affixed to the plate so as to form an integral unit therewith, and the plate is affixed to the upper end of the cane by the apparatus. In one embodiment of the apparatus, the upper end of the cane has a through bore and a threaded rod extends rearwardly from the plate and through the through bore where it threadably engages a nut. In another embodiment of the apparatus, a collar extends rearwardly from the plate and captures the upper end of the cane.

### BACKGROUND OF THE INVENTION

1. Field of the Invention

The present invention relates to a an audio/visual warning device. More particularly, the present invention relates to an audio/visual warning device for attaching to a cane and the cane therewith.

2. Description of the Prior Art

Numerous innovations for walking sticks have been provided in the prior art that will be described infra. Even though these innovations may be suitable for the specific individual purposes to which they address, however, they differ from the present invention.

FOR EXAMPLE, U.S. Pat. No. 4,013,881 to Sargent teaches a walking cane having tubular shafts in its construction through which a switch means and flashing lamp means extend and on which a cover member is secured to house said flashing lamp means. The cover member at a point 8 inches upwards from the ground end of tubular cane is of translucent substance (Lucite) thereby exposing the inner Lucite tubular “string reflector” flashing light beams. The rubber safety grip at the cane's end has a central opening permitting light beams to escape in the direction in which the cane is pointed. The batteries are housed in tandem fashion at a vantage point inside the tubular cane shaft for proper balance. The cane handle portion is easily removed for replacement of batteries and light bulb. The rubber safety grip at the ground end of the cane is removable for any adjustment of the string reflector and is moisture-proof.

ANOTHER EXAMPLE, U.S. Pat. No. 4,099,535 to Hubachek teaches a walking cane for the blind, visible during the day or night having an elongated tubular main shaft of light conducting material with a ground engaging tip secured to one end and a tubular handle to the other end. A cover of translucent white light transmitting material envelops most of the outer surface of the shaft and outer surface of the handle, but a portion of the shaft above the ground engaging tip is exposed to provide a window for the emission of light. This window may be dyed with a red translucent material. A solid rod of light conducting material resides within the tubular shaft and has a roughened outer surface portion which diffuses light directed axially along the shaft toward the exposed portion of the shaft. A spirally wrapped layer of pliable light transmitting plastic film envelops the rest of the outer surface of the rod and diffuses the light toward the white cover. A light generator, which can be turned on and off at will, is removably positioned within the handle for directing light axially through the shaft to cause the red and white cover to gloss brightly.

STILL ANOTHER EXAMPLE, U.S. Pat. No. 4,236,544 to Osaka teaches a safety-enhancing walking stick incorporating a light source which produces periodic flashes of high intensity light and is powered by self-contained batteries, the generation of the light flashes being controlled in accordance with the ambient illumination level.

YET ANOTHER EXAMPLE, U.S. Pat. No. 4,583,080 to DiVito et al. teaches an attachment for a walking cane to serve as audible alarm producing means and as a light projection lamp. The attachment has a hollow, casing for mounting onto a cane so that a vertical portion of the cane protrudes from the front section of the casing and the horizontal portion of the cane protrudes from the rear section of the casing. Inside the casing, is a switch connected in circuit with an audible alarm producing device, a lamp and batteries. The switch is operable externally of the casing for selectively sounding the alarm or lighting the lamp. The casing has quickly separable and reengageable sections providing access to the interior or the casing for servicing the batteries. The sound actuating circuit may be arranged to modify the sound produced by the alarm device to increase its attention getting effect.

STILL YET ANOTHER EXAMPLE, U.S. Pat. No. 5,973,618 TO Ellis teaches a portable safety mechanism housed in a cane, a walking stick or a belt-carried housing. In each of such embodiments, the portable safety mechanism includes a processor, a transmitter, a receiver, and an outside image sensor or scanner, a warning device such as an audible warning device or warning light. The scanner may for example, sense the shape of a traffic signal or the color of a traffic signal.

YET STILL ANOTHER EXAMPLE, U.S. Pat. No. 6,394,116 to Winn et al. teaches an illuminated walking assistance apparatus in the form of a staff having a light pipe in the lower portion thereof which provides diffused illumination in the immediate vicinity of the apparatus and at the same time, a bright light visible for a substantial distance to alert or signal others.

It is apparent that numerous innovations for walking sticks have been provided in the prior art that are adapted to be used. Furthermore, even though these innovations may be suitable for the specific individual purposes to which they address, however, they would not be suitable for the purposes of the present invention as heretofore described.

### SUMMARY OF THE INVENTION

ACCORDINGLY, AN OBJECT of the present invention is to provide an audio/visual warning device for attaching to a cane and the cane therewith that avoids the disadvantages of the prior art.

ANOTHER OBJECT of the present invention is to provide an audio/visual warning device for attaching to a cane and the cane therewith that is simple and inexpensive to manufacture.

STILL ANOTHER OBJECT of the present invention is to provide an audio/visual warning device for attaching to a cane and the cane therewith that is simple to use.

BRIEFLY STATED, YET ANOTHER OBJECT of the present invention is to provide an audio/visual warning device for attaching to a cane and the cane therewith. The cane has an upper end, a lower end, an extended position, and a collapsed position, and includes a plurality of separate tubular members affixed end-to-end, when the cane is in the extended position thereof and folded, side-by-side, when the cane is in the collapsed position thereof, and an elastic cord extends axially in the cane and is affixed, at one end thereof, to the upper end of the cane and, at the other end thereof, to the lower end of the cane so as to allow the plurality of separate and tubular members to be maintained end-to-end in the extended position of the cane, yet be separated axially from each other and be maintained side-by-side in the collapsed position of the cane. The audio/visual warning device includes a plate, a manual bell, a light, and apparatus for attaching the plate to the upper end of the cane. The manual bell and the light are affixed to the plate, and the plate is affixed to the upper end of the cane by the apparatus. In one embodiment of the apparatus, the upper end of the cane has a through bore extending diametrically therethrough and a threaded rod extends rearwardly from the plate and through the through bore in the upper end of the cane where it threadably engages a nut. In another embodiment of the apparatus, a collar extends rearwardly from the plate and captures the upper end of the cane.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawing are briefly described as follows:

FIG. 1 is a diagrammatic perspective vies of the present invention in use;

FIG. 2 is an enlarged diagrammatic perspective view of the area generally enclosed by the dotted curve identified b) ARROW 2 in FIG. 1 of the present invention in toto;

FIG. 3 is an enlarged diagrammatic cross sectional vie of the area generally enclosed by the dotted curve identified bit ARROW 3 in FIG. 2;

FIG. 4 is an enlarged diagrammatic perspective view of the area generally enclosed by the dotted curve identified by ARROW 4 in FIG. 2 of the audio/visual warning device of the present invention:

FIG. 5 is a diagrammatic top plan view of the area generally enclosed by the dotted curve identified by ARROW 5 in FIG. 4 of a first embodiment of the apparatus for attaching the audio/visual warning device to a cane; and

FIG. 6 is a diagrammatic top plan view of the area generally enclosed by the dotted curve identified by ARROW 6 in FIG. 4 of a second embodiment of the apparatus for attaching the audio/visual warning device to a cane.

### LIST OF REFERENCE NUMERALS UTILIZED IN THE DRAWING

10 audio/visual warning device for attaching to cane 12 and cane 12 therewith

12 cane

14 upper end of cane 12

16 lower end of cane 12

18 plurality of separate tubular members of cane 12

20 elastic cord of cane 12

22 spring-loaded button extending outwardly from looser one of two adjacent ones of plurality of separate and tubular members 18 of cane 12

24 plurality of bores in upper one of two adjacent ones of plurality of separate and tubular members 18

26 plate of audio/visual warning device 10

28 manual bell of audio/visual warning device 10

30 light of audio/visual warning device 10

32 apparatus for attaching plate 26 of audio/visual warning device 10 to upper end 14 of cane 12

First Embodiment of Apparatus 32

132 apparatus for attaching plate 26 of audio/visual warning device 10 to upper end 14 of cane 12

134 through bore in upper end 14 of cane 12 of apparatus 132

136 threaded rod of apparatus 132

138 nut of apparatus 132

Second Embodiment of Apparatus 32

232 apparatus for attaching plate 26 of audio/visual warning device 10 to upper end 14 of cane 12

240 collar of apparatus 232

242 two halves of collar 240 of apparatus 232

244 pair of screws of apparatus 232

### DETAILED DESCRIPTION OF THE PREFERRED EMBODIMENT

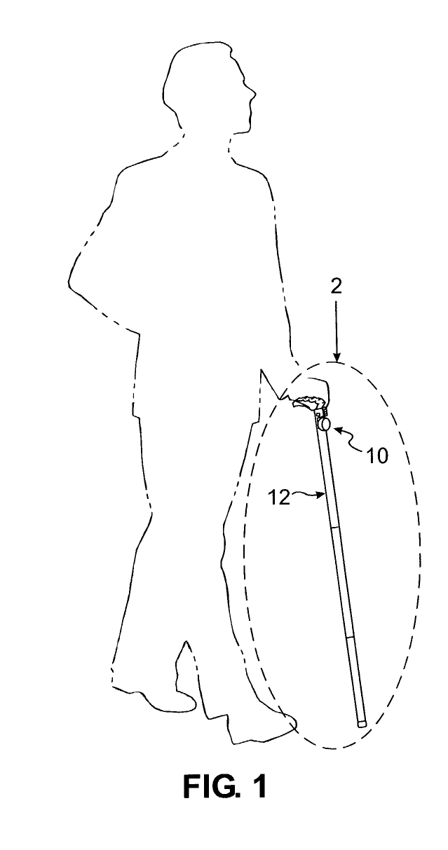

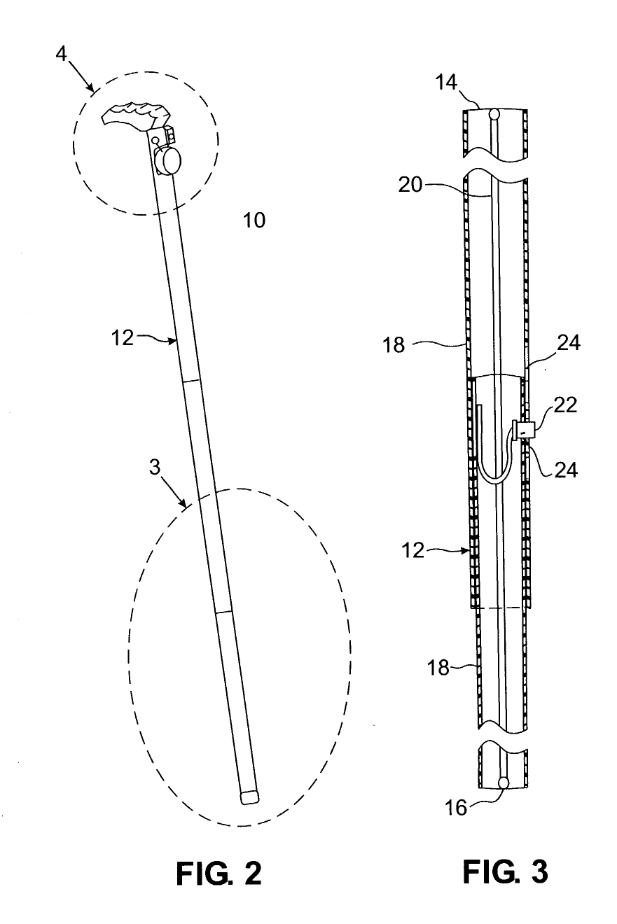

Referring now to the figures, in which like numerals indicate like parts, and particularly to FIGS. 1 and 2, which are respectively, a diagrammatic perspective view of the present invention in use, and an enlarged diagrammatic perspective view of the area generally enclosed by the dotted curve identified by ARROW 2 in FIG. 1 of the present invention in toto, the audio/visual warning device is shown generally at 10 for attaching to a cane 12 and the cane 12 therewith.

The specific configuration of the cane 12 can best be seen in FIG. 3, which is an enlarged diagrammatic cross sectional view of the area generally enclosed by the dotted curve identified by ARROW 3 in FIG. 2, and as such, will be discussed with reference thereto.

The cane 12 has an upper end 14, a lower end 16, an extended position, and a collapsed position, and comprises a plurality of separate tubular members 18 affixed, end-to-end, when the cane 12 is in the extended position thereof, and folded side-by-side, when the cane 12 is in the collapsed position thereof.

The cane 12 further comprises an elastic cord 20. The elastic cord 20 extends axially in the cane 12, and is affixed, at one end thereof, to the upper end 14 of the cane 12 and, at the other end thereof, to the lower end 16 of the cane 12 so as to allow the plurality of separate and tubular members 18 to be maintained, end-to-end, in the extended position, yet be separated axially from each other and be maintained, side-by-side, in the collapsed position.

Two adjacent ones of the plurality of separate and tubular members 18 are telescopically interrelated. A lower one of the two adjacent separate and tubular members 18 has a spring-loaded button 22. The spring loaded button 22 extends outwardly from the lower one of the two adjacent separate and tubular members 18. An upper one of the two adjacent separate and tubular members 18 has a plurality of bores 24. The plurality of bores 24 extend laterally through, and are longitudinally spaced along, the upper one of the two adjacent separate and tubular members 18. A selected one of the plurality of bores 24 receives the spring-loaded button 22 as the lower one of the two adjacent separate and tubular members 18 moves in the upper one of the two adjacent sepal-ate and tubular members 18 so as to length adjust the cane 12.

The selected one of the plurality of bores 24 receiving the spring-loaded button 22 maintains the two adjacent separate and tubular members 18 axially when the cane 12 is in the extended position thereof, and the selected one of the plurality of bores 24 disengaging from the spring-loaded button 22 allows the lower one of the two adjacent separate and tubular members 18 to telescope into the upper one of the two adjacent separate and tubular members 18 when the cane 12 is in the collapsed position thereof.

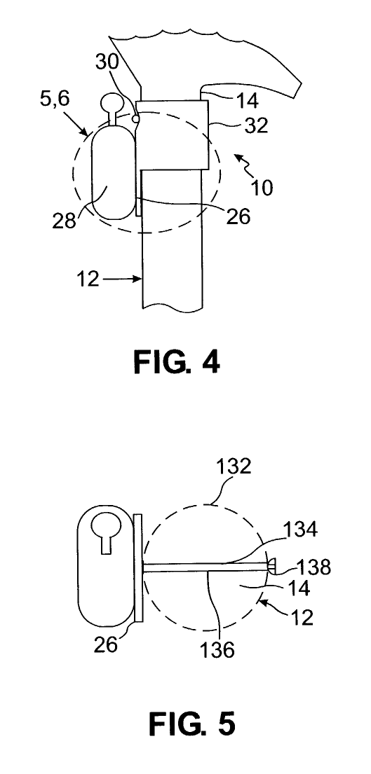

The specific configuration of the audio/visual warning device 10 can best be seen in FIG. 4, which is an enlarged diagrammatic perspective view of the area generally enclosed by the dotted curve identified by ARROW 4 in FIG. 2 of the audio/visual warning device of the present invention, and as such, will be discussed with reference thereto.

The audio/visual warning device 10 comprises a plate 26, a manual bell 28, a light 30, and apparatus 32 for attaching the plate 26 to the upper end 14 of the cane 12. The manual bell 28 and the light 30 are affixed to the plate 26 so as to form an integral unit therewith, and the plate 26 is affixed to the upper end 14 of the cane 12 by the apparatus 32. A typical example of the manual bell 28 is taught b) U.S. Pat. No. 616,732 to Rockwell, which is incorporated herein by reference thereto.

The specific configuration of a first embodiment of the apparatus 132 can best be seen in FIG. 5. which is a diagrammatic top plan view of the area generally enclosed by the dotted curve identified by ARROW 5 in FIG. 4 of a first embodiment of the apparatus for attaching the audio/visual warning device to a cane, and as such, will be discussed with reference thereto.

The apparatus 132 comprises the upper end 14 of the cane 12 having a through bore 134. The through bore 134 extends diametrically through the upper end 14 of the cane 12.

The apparatus 132 further comprises a threaded rod 136. The threaded rod 136 extends rearwardly from the plate 26, and through the through bore 134 in the upper end 14 of the cane 12, where it threadably engages a nut 138.

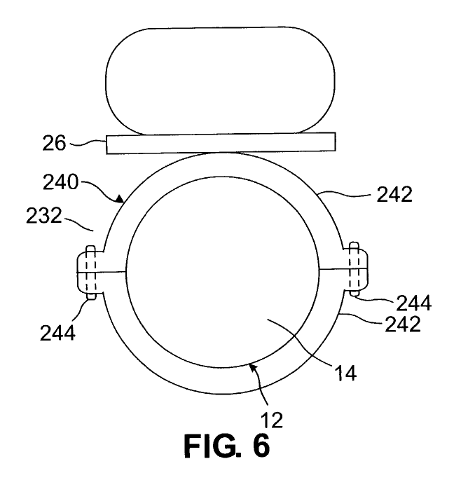

The specific configuration of a second embodiment of the apparatus 232 can best be seen in FIG. 6, which is a diagrammatic top plan view of the area generally enclosed by the dotted curve identified by ARROW 6 in FIG. 4 of a second embodiment of the apparatus for attaching the audio/visual warning device to a cane, and as such, will be discussed with reference thereto.

The apparatus 232 comprises a collar 240. The collar 240 extends rearwardly from the plate 26 and captures the upper end 14 of the cane 12. The collar 240 is diametrically separated into two halves 242. The two halves 242 of the collar 240 are attached to each other by a pair of screws 244 to facilitate attachment to the upper end 14 of the cane 12.

It will be understood that each of the elements described above, or two or more together, may also find a useful application in other types of constructions differing from the types described above.

While the invention has been illustrated and described as embodied in an audio/visual warning device for attaching to a cane and the cane therewith however, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. An audio/visual warning device for attaching to a cane and the cane therewith, comprising:
a) cane;
b) an audio/visual warning device; and
c) means for attaching said audio/visual warning device to said cane.

2. The combination as defined in claim 1, wherein said cane has an extended position;
wherein said cane has a collapsed position;
wherein said cane comprises a plurality of separate tubular members;
wherein said plurality of separate tubular members are affixed, end-to-end, when said
cane is in said extended position thereof; and
wherein said plurality of separate tubular members are folded, side-by-side, when said
cane is in said collapsed position thereof.

3. The combination as defined in claim 2, wherein said cane has an upper end;
wherein said cane has a lower end;
wherein said cane comprises an elastic cord;
wherein said elastic cord extends axially in said cane; and
wherein said elastic cord is affixed, at one end thereof, to said upper end of said cane
and, at the other end thereof, to said lower end of said cane so as to allow said plurality of separate and tubular members to be maintained, end-to-end, in said extended position of said cane, yet be separated axially from each other and be maintained, side-by-side, in said collapsed position of said cane.

4. The combination as defined in claim 2, wherein two adjacent ones of said plurality of separate and tubular members are telescopically interrelated;
wherein a lower one of said two adjacent separate and tubular members has a spring-loaded button;
wherein said spring loaded button extends outwardly, from said lower one of said two adjacent separate and tubular members;
wherein an upper one of said two adjacent separate and tubular members has a plurality of bores;
wherein said plurality of bores extend laterally through, and are longitudinally spaced along, said upper one of said two adjacent separate and tubular members;
wherein a selected one of said plurality of bores receives said spring-loaded button as said lower one of said two adjacent separate and tubular members moves in said upper one of said two adjacent separate and tubular members so as to length adjust said cane;
wherein said selected one of said plurality of bores receiving said spring-loaded button maintains said two adjacent separate and tubular members axially when said cane is in said extended position thereof; and
wherein said selected one of said plurality of bores disengaging from said spring-loaded button allows said lower one of said two adjacent separate and tubular members to telescope into said upper one of said two adjacent separate and tubular members when said cane is in said collapsed position thereof.

5. The combination as defined in claim 3, wherein said audio/visual warning device comprises a plate;
wherein said audio/visual warning device comprises a manual bell;
wherein said audio/visual warning device comprises a light:
wherein said audio/visual warning device comprises means for attaching said plate to said upper end of said cane;
wherein said manual bell and said light are is affixed to said plate so as to form an integral unit therewith; and
wherein said plate is affixed to said upper end of said cane by said means.

6. The combination as defined in claim 5, wherein said means comprises said upper end of said cane having a through bore: and
wherein said through bore in said upper end of said cane extends diametrically therethrough.

7. The combination as defined in claim 6, wherein said means comprises a threaded rod;
wherein said threaded rod extends rearwardly from said plate; and
wherein said threaded rod extends through said through bore in said upper end of said cane, where it threadably engages a nut.

8. The combination as defined in claim 5 wherein said apparatus comprises a collar;
wherein said collar extends rearwardly from said plate: and
wherein said collar captures said upper end of said cane.

9. The combination as defined in claim 8 wherein said collar is diametrically separated into two halves; and
wherein said two halves of said collar are attached to each other by a pair of screws to facilitate attachment to said upper end of said cane.
